(19) United States
(12) Patent Application Publication
(10) Pub. No.: US 2016/0066240 A1
(43) Pub. Date: Mar. 3, 2016

(54) COMMUNICATION SYSTEM, BASE STATION, AND COMMUNICATION METHOD

(71) Applicant: NEC CORPORATION, Tokyo (JP)

(72) Inventor: Takehiro SUZUKI, Tokyo (JP)

(21) Appl. No.: 14/784,290

(22) PCT Filed: May 7, 2014
(86) PCT No.: PCT/JP2014/002421

§ 371 Date: Oct. 14, 2015

(30) Foreign Application Priority Data
May 9, 2013 (DE) 2013-099435

(51) Int. Cl. H04W 36/26; H04W 72/10

(52) U.S. Cl. CPC H04W 36/26; H04W 72/10

(57) ABSTRACT

Provided is a communication system capable of handover processing, based on a processing priority according to handover classification. The communication system according to the embodiment of the present invention has a base station and a terminal; the terminal transmits handover requests to the base station; and the base station performs handover processing on the basis of the processing priority according to handover classification.

### TECHNICAL FIELD

The present invention relates to a communication system, a base station, and a communication method, which perform handover processing.

### BACKGROUND ART

There are mainly two kinds of handovers in an LTE (Long Term Evolution) system. One is an S1 handover that uses an S1 interface that is formed between a base station and a host device, such as a MME (Mobility Management Entity) and a S-GW (Serving Gateway). The other is an X2 handover that uses an X2 interface that is formed between base stations. In general, since an X2 handover does not traverse a MME, an X2 handover has an advantage of less delay in the handover processing and in data transmission during the handover compared with an S1 handover.

A technology relating to handovers in an LTE system is disclosed, for example, in Patent Document 1. In a system disclosed in Patent Document 1, if an X2 interface is functioning between wireless base stations, an X2 handover is performed, while, if the X2 interface is not functioning, an S1 handover is performed.

### CITATION LIST

### Patent Literature

Patent Document 1: Japan Patent Publication No. 2011-223525

### SUMMARY OF INVENTION

### Technical Problem

However, if a packet path for an X2 handover is congested, the processing of the X2 handover may possibly be delayed than the processing of an S1 handover. Further, there is a case where an X2 interface and an S1 interface are not established in a private IP (Internet Protocol) network where QoS (Quality of Service) and security are secured. For example, there is a case where a telecommunications carrier establishes or borrows a public IP network in order to suppress CAPEX (Capital Expenditure). When establishing such a public IP network, a handover processing message in an S1 handover and an X2 handover and a data transfer message in a handover are communicated in a best effort type communication.

Further, as frequency bands are not guaranteed in a network path and a network device, congestion is likely to occur on a packet path. That is, particularly when establishing a public IP network, the processing of an X2 handover is more likely to be delayed than the processing of an S1 handover.

As such, depending on the type of the IP network and the congestion state of the packet path, particularly in a public IP network, the processing of an X2 handover is sometimes delayed than the processing of an S1 handover. This problem is attributable to the fact that a handover is not processed according to processing priority based on the classification of the handover.

In consideration of the above problem, the objective of the present invention is to provide a communication system, a base station, and a communication method where handover processing can be performed according to processing priority based on the classification of the handover.

### Solution to Problem

The base station of the present invention has reception means that receives a handover request from a terminal and execution means that executes handover processing according to processing priority based on the classification of the handover.

The communication system of the present invention has a base station and a terminal, in which the terminal transmits a handover request to the base station, and the base station executes handover processing according to the processing priority based on the classification of the handover.

The communication method of the present invention comprises: receiving a handover request and executing handover processing according to processing priority based on the classification of the handover.

### Advantageous Effects of Invention

According to the present invention, processing of a handover can be executed according to processing priority based on the classification of the handover.

### BRIEF DESCRIPTION OF THE DRAWINGS

FIG. 1 is a block diagram showing a configuration of a communication system according to a first exemplary embodiment of the present invention;

FIG. 2 is a flowchart for illustrating operation of the communication system according to the first exemplary embodiment of the present invention;

FIG. 3 is a block diagram showing a configuration of a communication system according to a second exemplary embodiment of the present invention;

FIG. 4 is a block diagram showing a configuration of a base station according to the second exemplary embodiment of the present invention;

FIG. 5 is a diagram showing a configuration of a database managed by the base station according to the second exemplary embodiment of the present invention;

FIG. 6 is a diagram showing a configuration of the database managed by the base station according to the second exemplary embodiment of the present invention;

FIG. 7 is a sequence diagram for illustrating operation of a communication system according to the second exemplary embodiment of the present invention;

FIG. 8 is a sequence diagram for illustrating operation of the base station according to the second exemplary embodiment of the present invention;

FIG. 9 is a sequence diagram for illustrating operation of the communication system according to the second exemplary embodiment of the present invention;

FIG. 10 is a sequence diagram for illustrating operation of the base station according to the second exemplary embodiment of the present invention;

FIG. 11 is a diagram showing another example of a configuration of the database managed by the base station according to the second exemplary embodiment of the present invention;

FIG. 12 is a diagram showing a configuration of a database managed by a base station according to a third exemplary embodiment of the present invention;

FIG. 13 is a diagram showing a configuration of the database managed by the base station according to the third exemplary embodiment of the present invention;

FIG. 14 is a sequence diagram for illustrating operation of a communication system according to the third exemplary embodiment of the present invention;

FIG. 15 is a sequence diagram for illustrating operation of the communication system according to the third exemplary embodiment of the present invention; and

FIG. 16 is a sequence diagram for illustrating operation of the base station according to the third exemplary embodiment of the present invention.

### DESCRIPTION OF EMBODIMENTS

The following will describe exemplary embodiments of the present invention with reference to the drawings. However, the exemplary embodiments do not restrict the technical scope of the present invention.

### First Embodiment

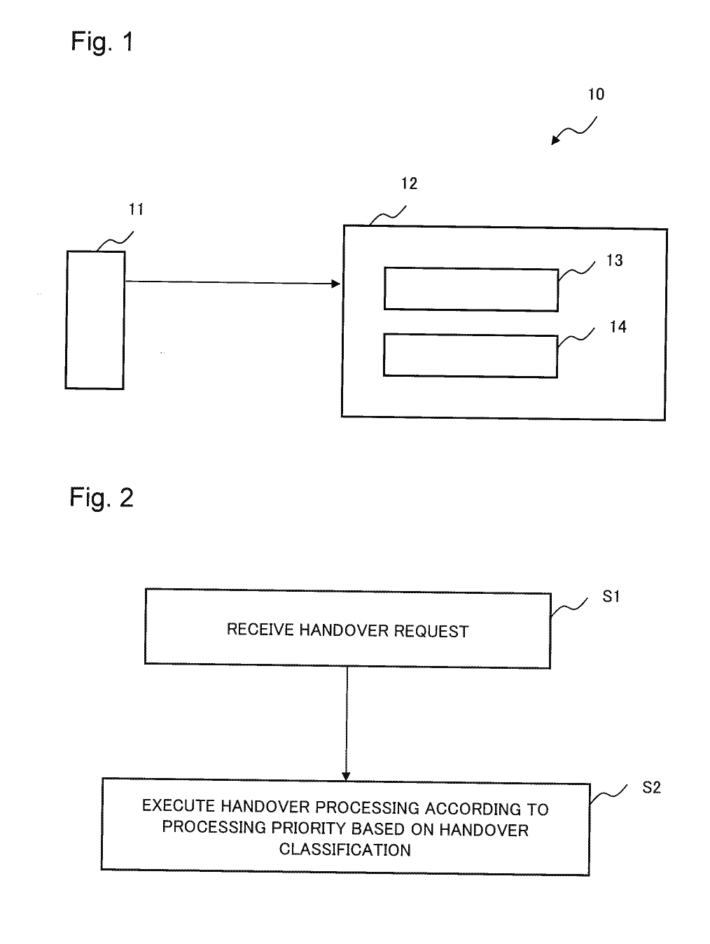

The communication system of the first exemplary embodiment of the present invention will be described with reference to FIG. 1.

The communication system 10 of the first exemplary embodiment has a terminal 11 and a base station 12 that communicates with the terminal 11. The base station 12 has a receiving unit 13 and an execution unit 14.

Next, the operation of the communication system 10 of the first exemplary embodiment will be described with reference to FIG. 2. First, the receiving unit 13 of the base station 12 receives a handover request from the terminal 11 (step S1). Then, the execution unit 14 of the base station 12 performs handover processing for the terminal 11 according to processing priority based on the handover classification (step S2).

It should be noted that the base station 12 may determine processing priority of a handover to be executed at step S2 in-between steps S1 and S2 based on the classification of the handover. Alternatively, other management device may determine processing priority based on the handover classification and notifies the base station 12 of the determined processing priority.

As described above, in the communication system 10 of the first exemplary embodiment, a handover can be processed according to processing priority based on the handover classification. Thus, even if congestion occurs in a packet path, the processing of an X2 handover can be preferentially processed over the processing of an S1 handover. As such, even if a public IP network where congestion tends to occur in a packet path is used, the processing of an X2 handover can be preferentially processed over the processing of an S1 handover.

It should be noted that the communication system of the first exemplary embodiment can be adapted to a communication system of, for example, LTE, WCDMA (Wideband Code Division Multiple Access) (registered trademark), and WiMAX (Worldwide Interoperability for Microwave Access).

### Second Embodiment

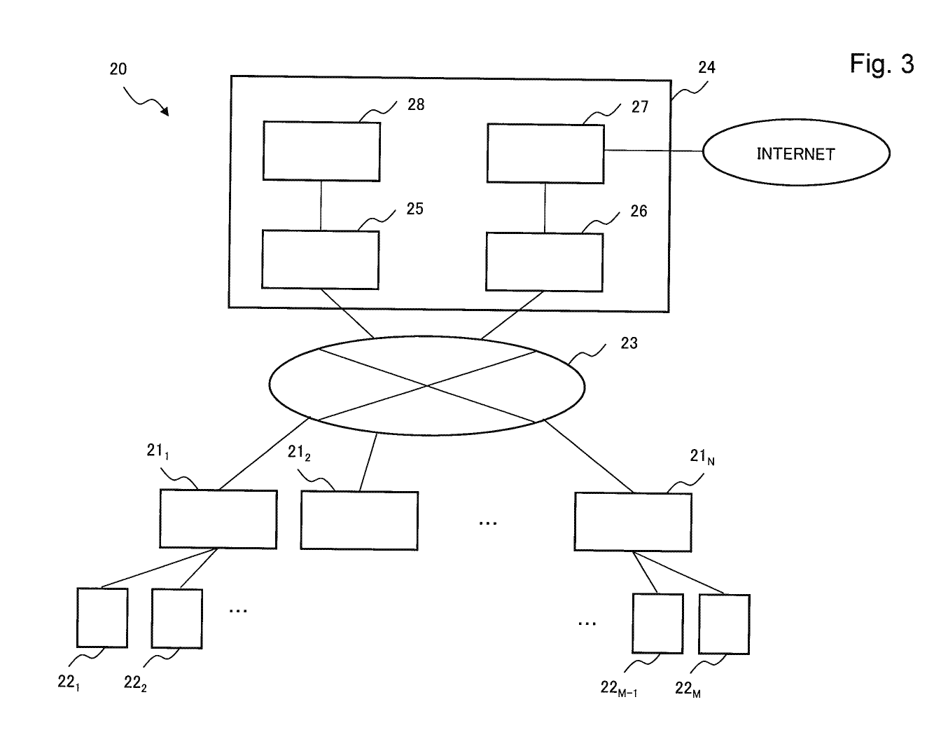

Next, the following will describe the communication system 20 of a second exemplary embodiment of the present invention with reference to FIG. 3. The communication system 20 in the second exemplary embodiment is an LTE system and has base stations 21_{1-N}, terminals 22_{1-M}, an IP network 23, and a core network 24.

The core network 24 has a MME (Mobility Management Entity) 25, a S-GW (Serving-Gateway) 26, a PDN-GW (Packet Data Network Gateway) 27, and a HSS (Home Subscriber Server) 28. The MME 25 performs a control relating to calling processing, such as, authentication of a terminal that uses LTE access, security management, mobility management, and session management thereof. The S-GW 26 deals with data transferring to a terminal that uses LTE access. The PDN-GW 27 is an anchor of data transferring to the Internet. Then, the HSS 28 performs authentication of a terminal and profiling.

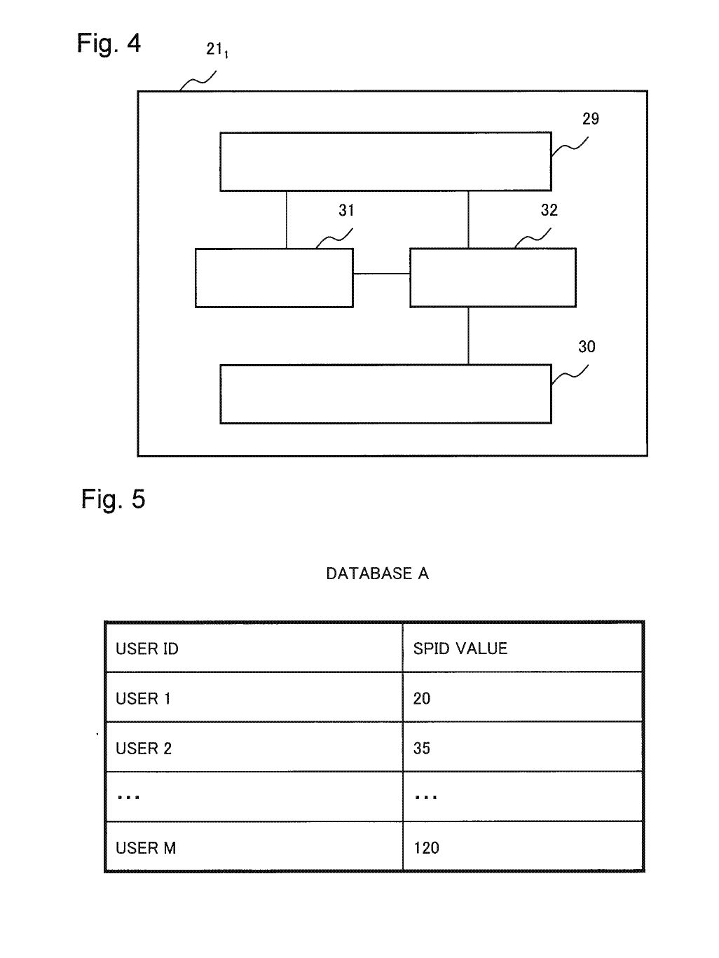

FIG. 4 shows the configuration of the base station 21₁. It should be noted that other base stations 21₂-21_{N} also have similar configurations. The base station 21₁ has a first transmitting/receiving unit 29, a second transmitting/receiving unit 30, a management unit 31, and a setting unit 32. The first transmitting/receiving unit 29 performs wired data transmitting/receiving using an S1 circuit and an X2 interface. The second transmitting/receiving unit 30 performs wireless data transmission/reception to and from the terminals 22₁-22_{M}. The management unit 31 manages information of SPID (Service Protocol Identifier) for respective users of terminals 22_{1-M}. The SPID is an index that is set for each terminal 22_{1-M}. The setting unit 32 stores a correspondence relationship among the value of SPID, the processing priority of a handover, and a QoS level. Then, the setting unit 32 determines a handover classification, as well as, sets processing priority and a QoS level based on the correspondence relationship. Then, the setting unit 32 notifies the first transmitting/receiving unit 29 of the determined handover classification and processing priority and notifies the second transmitting/receiving unit 30 of the set QoS level.

The database of SPID information for respective users of the terminals 22_{1-M}, which is managed by the management unit 31, is shown in FIG. 5. As shown in FIG. 5, a value of SPID is associated with each user ID in the database A that is managed by the management unit 31.

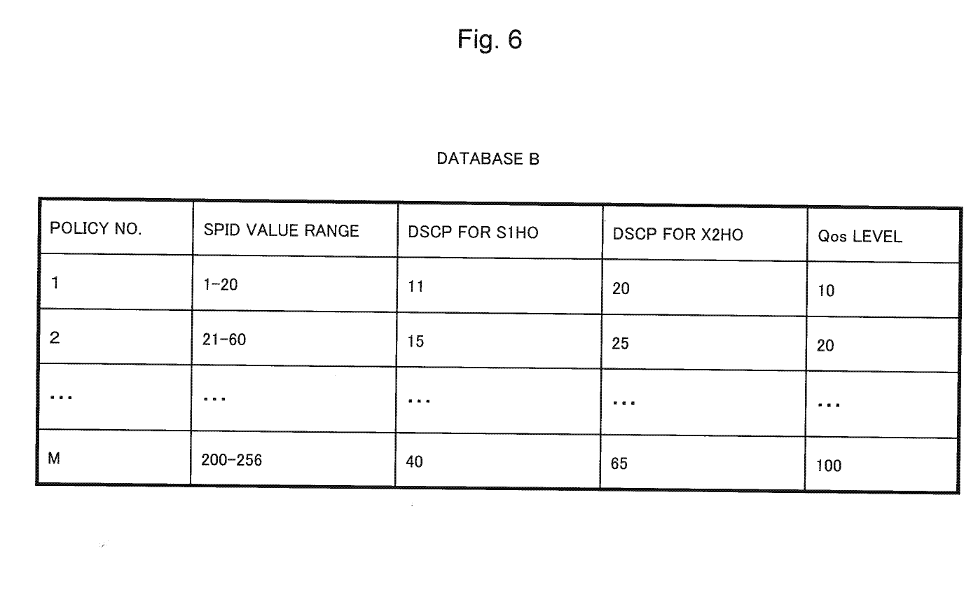

Next, the database that is stored in the setting unit 32 is shown in FIG. 6. The database B stored in the setting unit 32 is a database that sets a correspondence relationship among an SPID value, processing priority, and a QoS level. That is, as shown in FIG. 6, the processing priority of an S1 handover, the processing priority of an X2 handover, and a QoS level are respectively set for each predetermined range of SPID value. It should be noted that, in the second exemplary embodiment, DSCP (Differentiated Services Code Point) is used as an index of processing priority.

Then, the setting unit 32 appends DSCP as an index of processing priority to the handover processing message so that the handover processing will be processed with the set priority. Here, the DSCP of an X2 handover is set to a higher value than the DSCP of an S1 handover. That is, an X2 handover is set to have higher processing priority than an S1 handover. Further, terminals, to which services with higher QoS levels are provided, are set higher DSCP, that is, set to have higher processing priority.

Next, the operation of the communication system 20 of the second exemplary embodiment will be described.

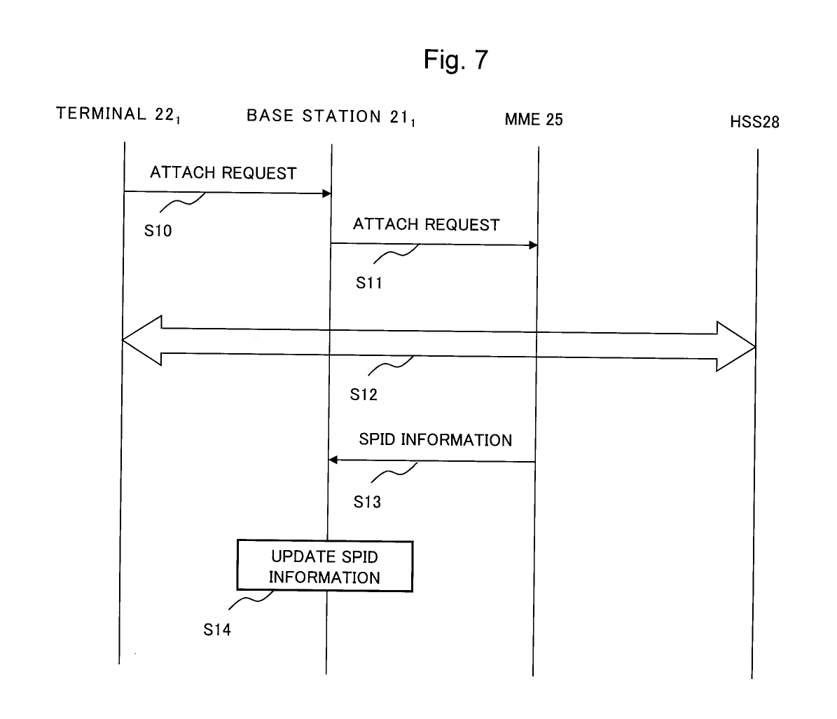

First, in Attach Procedure, the operation in which a base station 21₁ acquires SPID information of a terminal 22₁ will be described with reference to FIG. 7. The terminal 22₁, first, transmits Attach Request for requesting Attach to the base station 21₁ (step S10). The base station 21₁ that has received Attach Request from the terminal 22₁ transfers the Attach Request to the MME 25 (step S11). Next, among the terminal 22₁, MME 25, and HSS 28, processing relating to the authentication, concealment, and integrity control of the terminal 22₁ is performed (step S12). In the processing of this step S12, the HSS 28 transmits SPID information of the terminal 22₁ to the MME 25. Next, the MME 25 transmits SPID information of the terminal 22₁ that has been acquired from the HSS 28 at step S12 to the base station 21₁ (step S13). Here, the MME 25 may include the SPID information in the S1-AP: Initial Context Setup Request that is specified in 3GPP (3rd Generation Partnership Project) and transmit the SPID information to the base station 21₁.

Then, the base station 21₁ updates the management data that is managed by the base station 21₁ itself using the received SPID information (step S14). As such, the base station 21₁ acquires the SPID information of the terminal 22₁ in Attach Procedure. It should be noted that the procedure of Attach Procedure after step S14 may follow the processing specified in 3GPP.

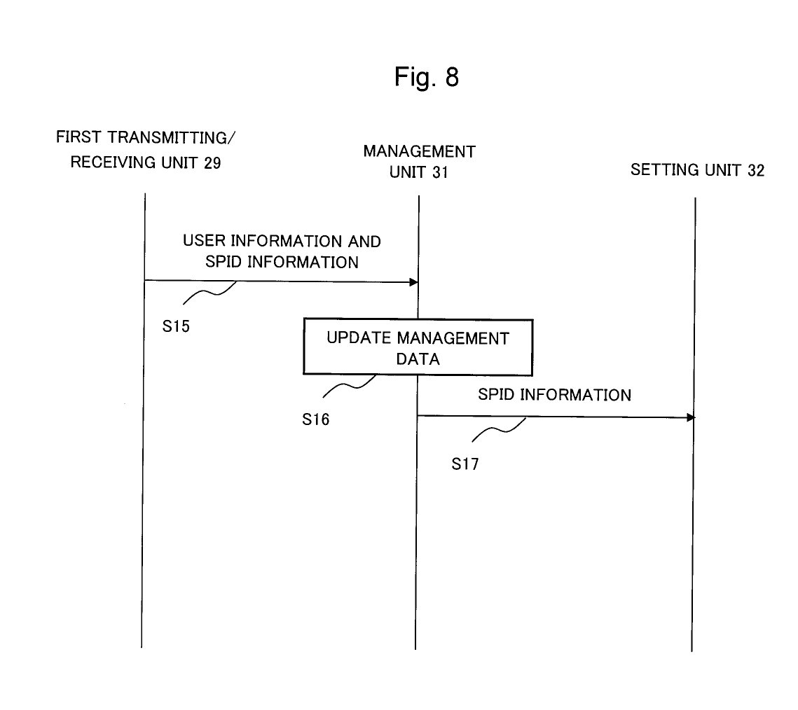

Next, the following will describe the detailed operation of step S14 shown in FIG. 7, that is, the operation of the base station 21₁ after acquiring the SPID information of the terminal 22₁ with reference to FIG. 8.

The first transmitting/receiving unit 29 of the base station 21₁ notifies the management unit 31 of the user information of the terminal 22₁ and the SPID information that was received from the MME 25 (step S15). The management unit 31 updates the database A shown in FIG. 5 using the received SPID information (step S16). Here, the management unit 31 may notify the setting unit 32 of the received SPID information (step S17). As such, the base station 21₁ manages the received SPID information.

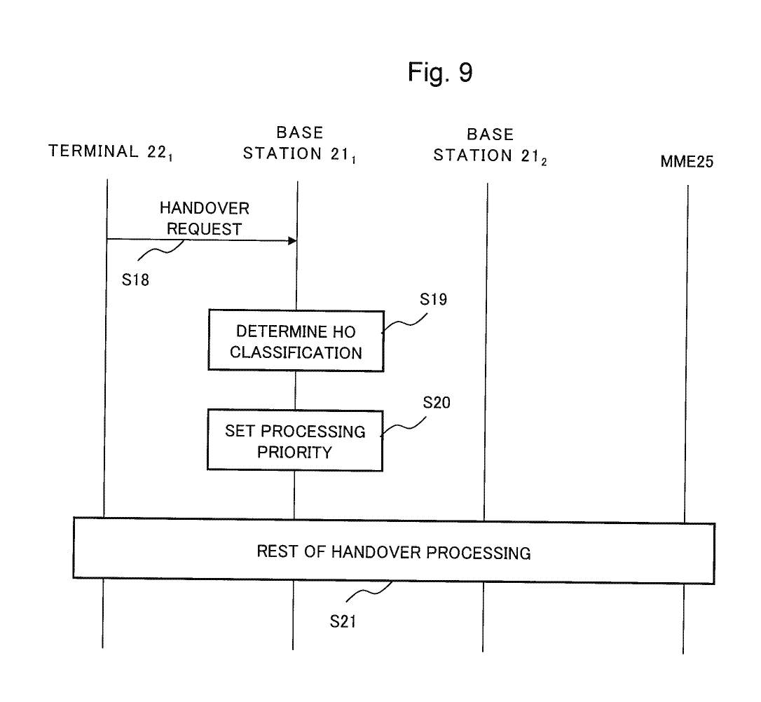

Next, the following will describe the operation in which the terminal 22₁ that has performed Attach Procedure shown in FIG. 7 performs a handover from the base station 21₁ to the base station 21₂, with reference to FIG. 9.

First, the terminal 22₁ requests the base station 21₁ for a handover to the base station 21₂ (step S18). The message of requesting a handover includes, for example, an RRC: Measurement Report message. The base station 21₁ that has received the handover request determines the classification of the handover based on the presence or absence of an X2 interface between the base station 21₁ and the base station 21₂ (step S19). In other words, if there is an X2 interface between the base station 21₁ and the base station 21₂, the base station 21₁ determines the classification of the handover to be performed by the terminal 22₁ as an X2 handover. On the other hand, if there is no X2 interface between the base station 21₁ and the base station 21₂, the base station 21₁ determines the classification of the handover to be performed by the terminal 22₁ as an S1 handover. Next, the base station 21₁ sets the processing priority of the handover requested by the terminal 22₁ based on the handover classification determined at step S19 (step S20). Then, based on the processing priority that has been set at step S20, the rest of the handover processing of the terminal 22₁ is performed among the terminal 22₁, base station 21₁, base station 21₂, and MME 25 (step S21). It should be noted that the handover processing of step S21 may follow the procedure of the handover processing that is specified in 3GPP.

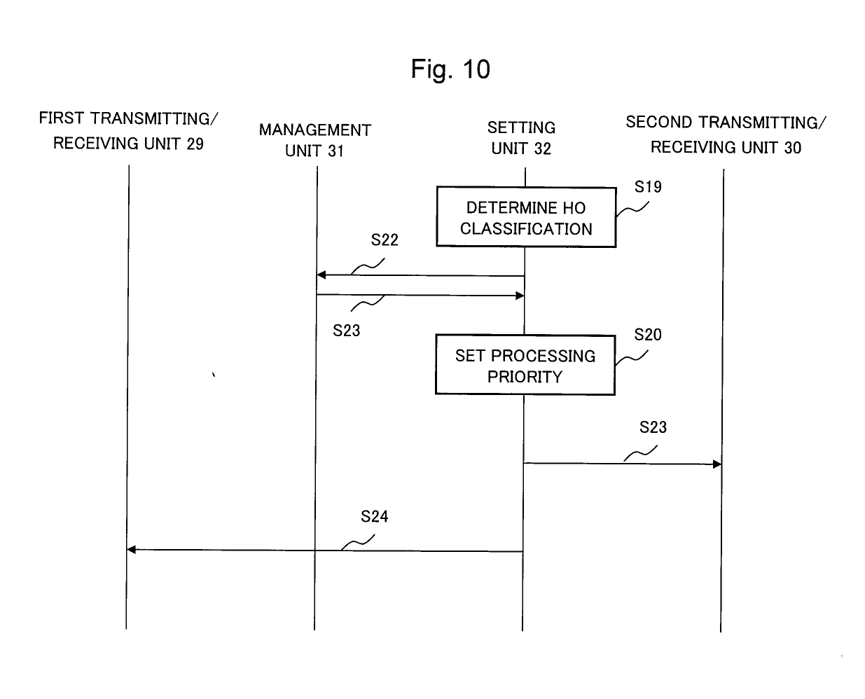

Next, the operation of the base station 21₁ at steps S19, S20 will be described with reference to FIG. 10. After determining the handover classification of the terminal 22₁ (step S19), the setting unit 32 of the base station 21₁ acquires SPID information that is associated with the user of the terminal 22₁ from the database A that is managed by the management unit 31 (steps S22, S23). Then, the setting unit 32 determines the processing priority of the handover of the terminal 22 based on the database B that is managed by the setting unit itself and the acquired SPID information (step S20). Specifically, the setting unit 32 sets the DSCP value of the handover of the terminal 22₁ and the QoS level thereof.

Next, the setting unit 32 notifies the second transmitting/receiving unit 30 of the QoS level that was set at step S20 (step S23). Then, the second transmitting/receiving unit 30 performs a communication with the terminal 22₁ in the handover processing of the terminal 22₁ at the QoS level. Further, the setting unit 32 notifies the first transmission part 29 of the DSCP value that was set at step S20 (step S24). Then, the first transmitting/receiving unit 29 uses the notified DSCP value for the communication with the IP network 23 in the handover processing of the terminal 221. As such, the base station 21₁ sets priority of handover processing of the terminal 22₁.

As such, in the communication system 20 of the second exemplary embodiment, processing priority can be set based on the handover classification. Therefore, even if the using network is a public IP network, an X2 handover can be preferentially processed over an S1 handover.

Further, in the second exemplary embodiment, the processing priority is set based on the range of the SPID value of the terminal 22₁. Thus, the processing priority of the handover, as well as, the QoS level, can be differentiated based on the classification of the service that the terminal is receiving. As such, a telecommunication carrier can control priority of handover processing for each user in order to increase ARPU (Average Revenue Per User). That is, the handover processing of terminals subscribing higher priced services can be preferentially performed over the handover processing of other terminals.

It should be noted that, although each of the base stations 21_{1-N} has a management unit and a setting unit in the second exemplary embodiment, the present invention is not limited to this. That is, a management device that controls a plurality of base stations of the communication system 20 may be newly added. Then, the management device may collectively manages the SPID information of the terminals that are connected to subordinate base stations and, further, set the processing priority.

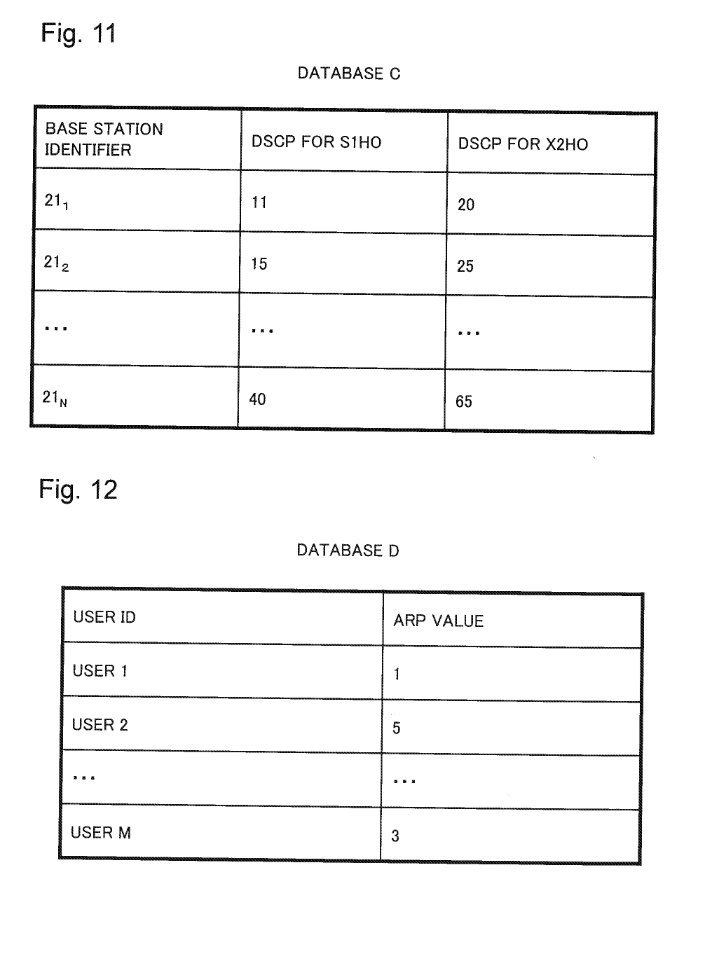

Further, in the second exemplary embodiment, as shown in FIGS. 5, 6, a policy number is determined based on the handover classification and the SPID value of a user, and the priority of the handover processing is determined according to the policy number, but the present invention is not limited to this. That is, the priority of the handover processing may be set based on the handover classification and other indexes that are set for respective users. Alternatively, the priority of handover processing may be set in each base station. In such a case, the setting unit 32 may have a database C shown in FIG. 11 instead of the database B shown in FIG. 6. That is, priority of handover processing may be set based on the identifier of a base station. In such a case, when having received a handover request from a terminal, the base station 21₁ sets the DSCP value to either 11 or 20 according to the handover classification and performs handover processing. As such, priority of handover processing can be set for each base station, that is, for each area (cell) where a terminal exists, instead of setting priority of handover processing for each user. Therefore, this method is effective when handover processing of a specific area is needed to be preferentially performed.

### Third Embodiment

Next, the following will describe a communication system of a third exemplary embodiment of the present invention. While the communication system of the third exemplary embodiment has the same configuration as the communication system 20 of the second exemplary embodiment shown in FIG. 3, the method of setting priority of handover processing is different. That is, in the third exemplary embodiment, the priority of handover processing is set according to an index that is set for each bearer, such as QoS classes and ARP (Allocation and Retention Priority), instead of the SPID value that is set for each user.

The QoS classes are classifications where a plurality of QoS levels are classified according to the degrees of delay and jitter; in 3GPP, QoS classes are classified into four classes—conversational class, streaming class, interactive class, and best effort class. The ARP is a kind of QoS parameter and an index that indicates processing priority among bearers in congestion control.

As an example of using an index that is set for each bearer, a method of using ARP for setting priority of handover processing will be described.

The management unit 31 of the base station 21₁ in the third exemplary embodiment has a database D shown in FIG. 12, instead of the database A shown in FIG. 5. In the database D shown in FIG. 12, each user ID of each terminal is associated with the ARP value of a bearer with the highest ARP among bearers used by each terminal.

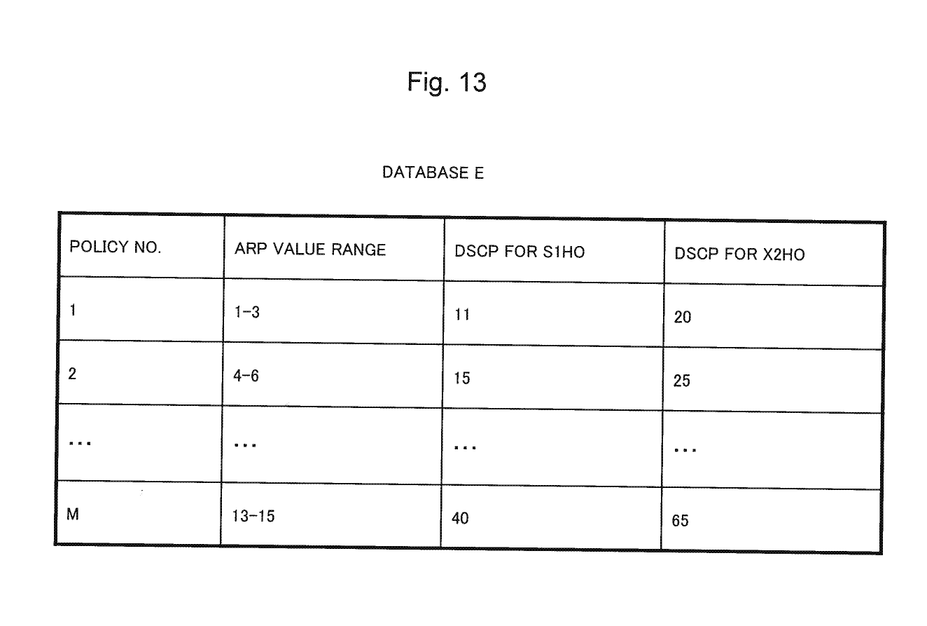

Further, the setting unit 32 of the base station 21₁ in the third exemplary embodiment has a database E shown in FIG. 13, instead of the database B shown in FIG. 6. The database E sets a correspondence relationship between an ARP value and processing priority. That is, as shown in FIG. 13, for each predetermined range of ARP value, the processing priority of an S1 handover and the processing priority of an X2 handover are respectively set.

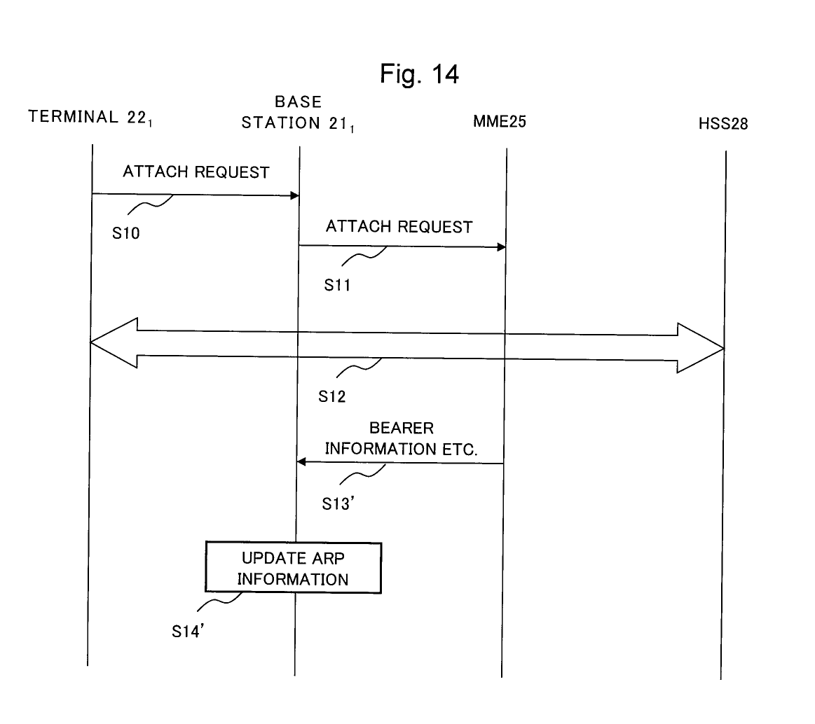

Next, the following will describe the operation that is different from the flows of FIGS. 7 and 9 that show operation of the communication system 20 of the second exemplary embodiment among the operation of the communication system of the third exemplary embodiment. As shown in FIG. 14, in the processing corresponding to step S13 of FIG. 7, the base station 21₁ of the third exemplary embodiment receives information of bearers established by the terminal 22₁ and information of the ARP value of each bearer from the MME 25, instead of SPID information or in addition to SPID information (step S13′).

Then, in the processing corresponding to step S14, the base station 21₁ updates ARP information corresponding to the user ID in the database D shown in FIG. 12 (step S14′).

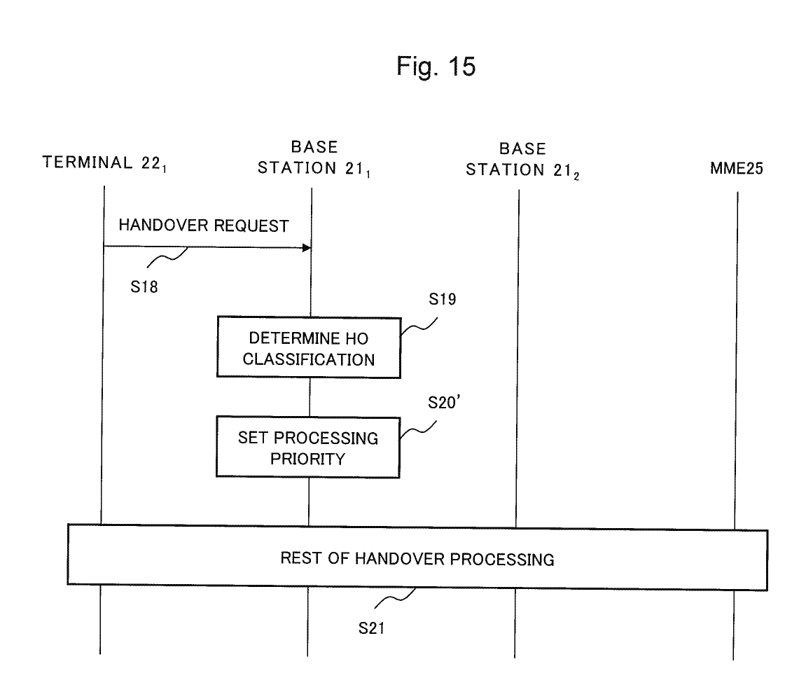

Further, as shown in FIG. 15, when the base station 21₁ determines a handover classification in FIG. 9 (step S19), the base station 21₁, in the processing corresponding to step S20, sets processing priority of a handover based on the databases D, E shown in FIGS. 12, 13 (step S20′).

As other steps shown in FIGS. 7 and 9 are the same as the second exemplary embodiment, the description thereof is omitted.

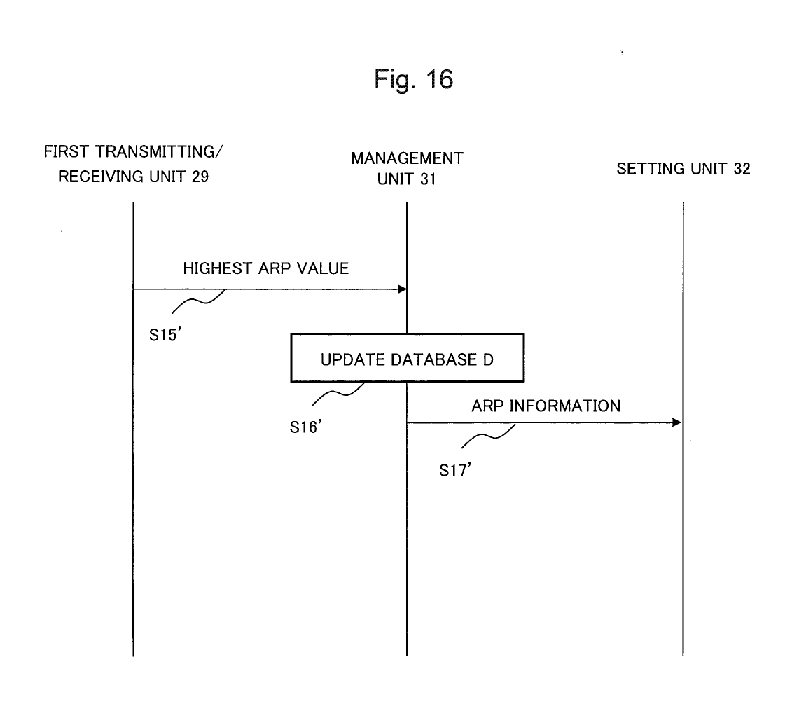

Next, the following will describe operation that is different from the flow of FIG. 8 that shows the operation of the base station 21₁ of the second exemplary embodiment among the operation of the base station 21₁ of the third exemplary embodiment. As shown in FIG. 16, in the processing corresponding to step S15 shown in FIG. 8, the first transmitting/receiving unit 29 of the base station 21₁ of the third exemplary embodiment transmits the user information of the terminal 22₁ and the highest ARP value among ARP of the bearers established by the terminal 22₁ to the management unit 31 (step S15′). The management unit 31, in the processing corresponding to step S16, updates the database D shown in FIG. 12 using the received user information and ARP information (step S16′). Then, the management unit 31, in the processing corresponding to step S17, notifies the ARP information of the terminal 22₁, instead of the SPID information of the user of the terminal 22₁ or in addition to the SPID information (step S17′).

As such, in the third exemplary embodiment, the priority of the handover processing can be controlled with ARP that is set for each bearer established by the terminal as an index.

It should be noted that ARP is used as an index of processing priority of a handover in the description of the operation of the third exemplary embodiment but the present invention is not limited to this. That is, instead of ARP, QoS classes that are set for respective bearers may be used.

Also, in setting the processing priority in the second exemplary embodiment and third exemplary embodiment, SPID values, ARP, QoS classes, and the like are used in addition to the handover classifications without limitation. For example, instead of SPID values, ARP, QoS classes, or in addition to such indexes, frequency of handovers performed by a terminal may be used as an index. Specifically, a base station acquires information of base stations, with which a terminal has previously communicated, from UE History Information that is included in a handover request message received from the terminal.

Then, using the number of the base stations, with which the terminal has previously communicated, as an index, the processing priority of a handover may be set. That is, handover processing of terminals that have a larger number of previously communicated base stations may be preferentially processed. Here, if a terminal has a large number of previously communicated base stations, the terminal is highly likely a terminal that moves at a high speed while frequently performing handovers. If handover processing of such a terminal delays, a wireless link between the terminal and the transfer source base station may be cut off before performing handover processing and during handover processing. In such a case, the terminal reconnects with the transfer destination base station without completing handover processing, which causes a decrease in the success rate of the handover processing and loss of data transferred in the handover processing. Thus, preferentially processing handover processing of terminals with a larger number of previously communicated base stations, can prevent a decrease in the success rate of the handover processing and loss of data transferred in the handover processing.

Further, the communication system in the second exemplary embodiment and third exemplary embodiment is an LTE communication system without limitation. That is, in addition to LTE, the operation of the base station in the communication systems of the first to third exemplary embodiments can also be applied to WCDMA and WiMAX base stations. In the case of WCDMA, handover classifications include, for example, an Inter MSC (Mobile Switching Center) handover/Inter SGSN (Serving GPRS (General Packet Radio Service) support node) handover and an Inter RNC (Radio Network Controller) handover.

Further, WiMAX handover classifications include R8HO (Reference-Point 8 Hand Over) and R6HO (Reference-Point 6 Hand Over). The R8HO is a handover between base stations and is equivalent to an X2 handover in the LTE system. Also, R6HO is known as a handover equivalent to an S1 handover in the LTE system.

Further, the respective operation of the communication systems that has been described in the first to third exemplary embodiments may be controlled by a device of the communication systems shown in FIGS. 1, 3, 7 or a CPU (Central Processing Unit) of other device that is communicable with such a device. In such a case, it should be appreciated that the operation can also be achieved by preparing a recording medium that stores software program codes that realize the functions of each exemplary embodiment and operating the program codes by the CPU by reading the program codes that are stored in the recording medium by a general computer.

It should be noted that the recording medium for providing a program may be any medium that can store the above-described program, such as, a CD-ROM (Compact Disc Read Only Memory), a DVD-R (Digital Versatile Disk Recordable), an optical disk, a magnetic disk, a non-volatile memory card.

Further, the types of base stations are not restricted in the first to third exemplary embodiments. That is, the base stations may be any of macro base stations that configure macrocells, pico base stations that configure picocells, and Femto base stations that configure Femtocells (HNB (Home NodeB) or HeNB).

The invention of the present application has been described so far with reference to the above-described embodiments, without limitation thereto. A variety of modifications that will be understood by those skilled in the art can be made to the configuration and details of the invention of the present application within the scope thereof.

This application claims priority based on Japanese Patent Application No. 2013-099435 filed on May 9, 2013, which application is incorporated herein in its entirety by disclosure.

The part or whole of the embodiments described above can as well be described as the following Supplementary Notes without limitation.

(Supplementary Note 1) A base station that has reception means that receives a handover request from a terminal and execution means that executes processing of the handover according to processing priority based on a classification of the handover.
(Supplementary Note 2) The base station according to Supplementary Note 1 further having means that determines processing priority based on the classification of the handover when the reception means has received the handover request.
(Supplementary Note 3) The base station according to either Supplementary Note 1 or 2, wherein the processing priority is DSCP that is determined based on the classification of the handover.
(Supplementary Note 4) The base station according to any one of Supplementary Notes 1 to 3, wherein the processing priority is set based on an index that is set for each of the terminal in addition to the classification of the handover.
(Supplementary Note 5) The base station according to any one of Supplementary Notes 1 to 3, wherein the processing priority is determined based on a classification of a service that the terminal subscribes in addition to the classification of the handover.
(Supplementary Note 6) The base station according to any one of Supplementary Notes 1 to 5, wherein the processing priority is set based on SPID of the terminal in addition to the classification of the handover.
(Supplementary Note 7) The base station according to any one of Supplementary Notes 1 to 3, wherein the processing priority is set based on an index that is set for each bearer that is formed between the terminal and the base station in addition to the classification of the handover.
(Supplementary Note 8) The base station according to Supplementary Note 7, wherein the index that is set for each of the bearer is ARP.
(Supplementary Note 9) The base station according to Supplementary Note 7, wherein the index that is set for each of the bearer is a QoS class.
(Supplementary Note 10) The base station according to any one of Supplementary Notes 1 to 3, wherein the processing priority is set based on a number of base stations, with which the terminal has previously communicated, in addition to the classification of the handover.
(Supplementary Note 11) A communication system that has a base station and a terminal, wherein the terminal transmits a handover request to the base station, and the base station executes processing of the handover according to processing priority based on a classification of the handover.
(Supplementary Note 12) The communication system according to Supplementary Note 10, wherein, when having received the handover request, the base station determines the processing priority based on the classification of the handover.
(Supplementary Note 13) The communication system according to either Supplementary Note 11 or 12, wherein the processing priority is DSCP that is determined based on the classification of the handover.
(Supplementary Note 14) The communication system according to any one of Supplementary Notes 11 to 13, wherein the processing priority is determined based on a classification of a service that the terminal subscribes in addition to the classification of the handover.
(Supplementary Note 15) The communication system according to any one of Supplementary Notes 11 to 13, wherein the processing priority is set based on an index that is set for each of the terminal in addition to the classification of the handover.
(Supplementary Note 16) The communication system according to any one of Supplementary Notes 11 to 15, wherein the processing priority is set based on SPID of the terminal in addition to the classification of the handover.
(Supplementary Note 17) The communication system according to any one of Supplementary Notes 11 to 13, wherein the processing priority is set based on an index that is set for each bearer that is formed between the terminal and the base station in addition to the classification of the handover.
(Supplementary Note 18) The communication system according to Supplementary Note 17, wherein the index that is set for each of the bearer is ARP.
(Supplementary Note 19) The communication system according to Supplementary Note 17, wherein the index that is set for each of the bearer is a QoS class.
(Supplementary Note 20) The communication system according to any one of Supplementary Notes 11 to 13, wherein the processing priority is set based on a number of base stations, with which the terminal has previously communicated, in addition to the classification of the handover.
(Supplementary Note 21) A communication method including: receiving a handover request and executing processing of the handover according to processing priority based on a classification of the handover.
(Supplementary Note 22) The communication method according to Supplementary Note 21 including determining processing priority based on the classification of the handover when having received the handover request.
(Supplementary Note 23) The communication method according to either Supplementary Note 21 or 22, wherein the processing priority is DSCP that is determined based on the classification of the handover.
(Supplementary Note 24) The communication method according to any one of Supplementary Notes 21 to 23, wherein the processing priority is determined based on a classification of a service that the terminal subscribes in addition to the classification of the handover.
(Supplementary Note 25) The communication method according to any one of Supplementary Notes 21 to 23, wherein the processing priority is set based on an index that is set for each of the terminal in addition to the classification of the handover.
(Supplementary Note 26) The communication method according to any one of Supplementary Notes 21 to 23, wherein the processing priority is set based on SPID of the terminal in addition to the classification of the handover.
(Supplementary Note 27) The communication method according to any one of Supplementary Notes 21 to 23, wherein the processing priority is set based on an index that is set for each bearer that is formed between the terminal and the base station in addition to the classification of the handover.
(Supplementary Note 28) The communication method according to Supplementary Note 27, wherein the index that is set for each of the bearer is ARP.
(Supplementary Note 29) The communication method according to Supplementary Note 27 wherein the index that is set for each of the bearer is a QoS class.
(Supplementary Note 30) The communication method according to any one of Supplementary Notes 21 to 23, wherein the processing priority is set based on a number of base stations, with which the terminal has previously communicated, in addition to the classification of the handover.
(Supplementary Note 31) A program that causes a computer to execute the steps of: receiving a handover request; and executing processing of the handover according to processing priority based on a classification of the handover.
(Supplementary Note 32) A computer-readable information recording medium wherein the recording medium stores the program according to Supplementary Note 31.

Reference Signs List

| | |
|---|---|
| 10, 20 | COMMUNICATION SYSTEM |
| 11, 22_{1-N} | TERMINAL |
| 12, 21_{1-N} | BASE STATION |
| 13 | RECEIVING UNIT |
| 14 | EXECUTION UNIT |
| 23 | IP NETWORK |
| 24 | CORE NETWORK |
| 25 | MME |
| 26 | S-GW |
| 27 | PDN-GW |
| 28 | HSS |
| 29 | FIRST TRANSMITTING/RECEIVING UNIT |
| 30 | SECOND TRANSMITTING/RECEIVING UNIT |
| 31 | MANAGEMENT UNIT |
| 32 | SETTING UNIT |

1. A base station comprising:
a receiver configured to receive a handover request from a terminal; and
a processor configured to execute processing of a handover according to processing priority based on a classification of the handover.

2. The base station according to claim 1 further comprising a setting unit configured to determine the processing priority based on the classification of the handover when the receiver has received the handover request.

3. The base station according to claim 1,
wherein the processing priority comprises Differentiated Services Code Point (DSCP) that is determined based on the classification of the handover.

4. The base station according to claim 1,
wherein the processing priority is set based on an index that is set for the terminal in addition to the classification of the handover.

5. The base station according to claim 4,
wherein the index comprises Service Protocol Identifier (SPID) of the terminal.

6. The base station according to claim 1,
wherein the processing priority is set based on an index that is set for a bearer that is formed between the terminal and the base station in addition to the classification of the handover.

7. The base station according to claim 6,
wherein the index is Allocation and Retention Priority (ARP) or a Quality of Service (QoS) class.

8. The base station according to claim 1,
wherein the processing priority is set based on the number of base stations, with which the terminal has previously communicated, in addition to the classification of the handover.

9. (canceled)

10. A communication method comprising:
receiving a handover request; and
executing processing of the handover according to processing priority based on a classification of the handover.

11. A terminal comprising:
a transmitter configured to transmit a handover request to a base station; and
a processor configured to execute processing of a handover according to processing priority which the base station is set based on a classification of the handover.

12. The base station according to claim 2,
wherein the processing priority comprises Differentiated Services Code Point (DSCP) that is determined based on the classification of the handover.

13. The base station according to claim 2,
wherein the processing priority is set based on an index that is set for the terminal in addition to the classification of the handover.

14. The base station according to claim 3,
wherein the processing priority is set based on an index that is set for the terminal in addition to the classification of the handover.

15. The base station according to claim 2,
wherein the processing priority is set based on an index that is set for a bearer that is formed between the terminal and the base station in addition to the classification of the handover.

16. The base station according to claim 3,
wherein the processing priority is set based on an index that is set for a bearer that is formed between the terminal and the base station in addition to the classification of the handover.

17. The base station according to claim 2, wherein the processing priority is set based on the number of base stations, with which the terminal has previously communicated, in addition to the classification of the handover.

18. The base station according to claim 3, wherein the processing priority is set based on the number of base stations, with which the terminal has previously communicated, in addition to the classification of the handover.

19. The base station according to claim 12, wherein the processing priority is set based on an index that is set for the terminal in addition to the classification of the handover.

20. The base station according to claim 12,
wherein the processing priority is set based on an index that is set for a bearer that is formed between the terminal and the base station in addition to the classification of the handover.

21. The base station according to claim 12, wherein the processing priority is set based on the number of base stations, with which the terminal has previously communicated, in addition to the classification of the handover.
